(19) United States
(12) Patent Application Publication
(10) Pub. No.: US 2026/0060249 A1
(43) Pub. Date: Mar. 5, 2026

(54) NEW PYRIDINIUM SALT-BASED CHEMICALS AS BIOCIDE AND THEIR USE

(71) Applicant: Saudi Arabian Oil Company, Dhahran (SA)

(72) Inventors: Muhammad Imran Ulhaq, Dhahran (SA); Xiangyang Zhu, Dhahran (SA)

(73) Assignee: Saudi Arabian Oil Company, Dhahran (SA)

(21) Appl. No.: 18/824,564

(22) Filed: Sep. 4, 2024

(51) Int. Cl. A01N 43/40

(52) U.S. Cl. CPC A01N 43/40

(57) ABSTRACT

A process for inhibiting microbial growth comprising administering a formulation comprising a pyridinium chloride compound of Formula (I), described herein, wherein R₁-R₆, independently comprise hydrogen, substituted or unsubstituted C₁ to C₂₄ alkyl, substituted or unsubstituted alkylaryl, substituted or unsubstituted aryl, substituted or unsubstituted heteroaryl, substituted or unsubstituted alkenyl, substituted or unsubstituted alkynyl, sulfonate, aryl sulfonate, C₁ to C₂₄ alkyl sulfonate, taurine, carboxylate, amine, alkylamine, arylamine, alkylammonium, arylammonium, sulfonamide, halogen, hydroxy, amide, nitro, cyano, azide, O-alkyl, S-alkyl, silyl, trialkylsilyl, O-silyl, haloalkyl, alkylsulfhydryl, trifluoromethyl, hydrazide, substituted or unsubstituted aryl, heteroaryl, or heterocyclic alkynyl, carboxyalkyl, aminoalkyl, haloalkyl, azidoalkyl, amide, amino acid, or peptide; and X and Y independently comprise a heteroatom selected from oxygen, nitrogen, or sulfur, or a heterocarbyl comprising one or heteroatoms selected from oxygen, nitrogen, or sulfur.

### TECHNICAL FIELD

Embodiments of the present disclosure generally relate to formulations and processes for inhibiting microbial growth and, more specifically, to processes for reducing microorganisms comprising administering a biocide formulation comprising a pyridinium chloride compound and their use for mitigating corrosion and microbial growth.

### BACKGROUND

Microorganisms such as bacteria pose major safety challenges to operations in the oil and gas industry through biofouling and microbial-induced corrosion (MIC). The anaerobic atmosphere in subsurface reservoirs promotes the growth of biofilm-forming, sulfate-reducing microorganisms. These sulfate reducers metabolize certain sulfate sources, releasing undesirable hydrogen sulfide (H₂S). Dissolved gases, including H₂S, and carbon dioxide (CO₂) cause “sour and sweet” corrosion, behaving like weak acids and promoting steel corrosion. In the absence of adequate microbiological growth control and corrosion inhibition, a number of issues arise including pipeline blockages, biofilm growth, and bacterial H₂S production, all of which contribute to MIC. Such issues can result in high maintenance costs, discontinuity of operations, and low capacity production. The oil and gas industry employs biocides to mitigate challenges caused by bio organisms or bacteria. To mitigate microbial control and sweet and sour corrosion during oil and gas production, transportation, and processing, biocides are commonly injected into pipeline fluids.

Mitigating microbial control and pipeline corrosion in wet sour environments is a particular challenge for the oil and gas industry. Some of the most common biocide formulations retard metallic corrosion by adsorbing onto the metal surface to create inhibitor barriers between the metal surface and the corrosive environment. Perhaps, the notable class of industrial biocides for reducing germ load comprises an oxidizing biocide, which lowers bacteria counts within minutes. Commonly used biocide formulations include organic “fast killing” compounds such as THPS, TTPC, Quats, DBNPA, Glut, and formaldehyde releasers. Furthermore, there are a number of active intermediates that work as dual products for microbial and corrosion inhibition, however their low thermal stabilities make them less ideal as biocides.

Thus, there is a need for dual biocide formulations that may be used as biocides as well as products for microbial and corrosion inhibition.

### SUMMARY

Embodiments of the processes described herein meet this need through the inclusion of compounds comprising a pyridinium chloride compound of Formula (I)

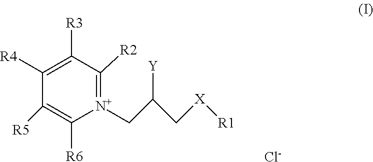

wherein R₁-R₆, independently comprise hydrogen, substituted or unsubstituted C₁ to C₂₄ alkyl, substituted or unsubstituted alkylaryl, substituted or unsubstituted aryl, substituted or unsubstituted heteroaryl, substituted or unsubstituted alkenyl, substituted or unsubstituted alkynyl, sulfonate, aryl sulfonate, C₁ to C₂₄ alkyl sulfonate, taurine, carboxylate, amine, alkylamine, arylamine, alkylammonium, arylammonium, sulfonamide, halogen, hydroxy, amide, nitro, cyano, azide, O-alkyl, S-alkyl, silyl, trialkylsilyl, O-silyl, haloalkyl, alkylsulfhydryl, trifluoromethyl, hydrazide, substituted or unsubstituted aryl, heteroaryl, or heterocyclic alkynyl, carboxyalkyl, aminoalkyl, haloalkyl, azidoalkyl, amide, amino acid, or peptide; and X and Y independently comprise a heteroatom selected from oxygen, nitrogen, or sulfur, or a heterocarbyl comprising one or heteroatoms selected from oxygen, nitrogen, or sulfur. As used herein, the pyridinium chloride compound of Formula (I) may be an active compound in the formulation or an intermediate compound.

Additional features and advantages of the described embodiments will be set forth in the detailed description which follows, and in part will be readily apparent to those skilled in the art from that description or recognized by practicing the described embodiments, including the detailed description which follows, the claims, as well as the appended drawings.

It is to be understood that both the foregoing general description and the following detailed description describe various embodiments and are intended to provide an overview or framework for understanding the nature and character of the claimed subject matter.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic representation of the optical density measurements and growth curves of undiluted and diluted GAB cultures in the absence of CI treatment according to one or more embodiments shown and described herein;

FIG. 2 is a schematic representation of the optical density measurements and growth curves of GAB cultures in the conditions of continuous exposure to low concentrations of sample-162 according to one or more embodiments shown and described herein;

FIG. 3 is a schematic representation of the optical density measurements and growth curves of GAB cultures in the conditions of continuous exposure to low concentrations of sample-181 according to one or more embodiments shown and described herein;

FIG. 4 is a schematic representation of the optical density measurements and growth curves of undiluted and diluted GAB cultures after centrifugation and in the absence of exposure to biocide according to one or more embodiments shown and described herein;

FIG. 5 is a schematic representation of the optical density measurements and growth curves of GAB cultures after 1 hour of exposure to high concentrations of Sample 162 according to one or more embodiments shown and described herein;

FIG. 6 is a schematic representation of the optical density measurements and growth curves of GAB cultures after 2 hours of exposure to high concentrations of Sample 162 according to one or more embodiments shown and described herein;

FIG. 7 is a schematic representation of the optical density measurements and growth curves of GAB cultures after 4 hours of exposure to high concentrations of Sample 162 according to one or more embodiments shown and described herein;

FIG. 8 is a schematic representation of the optical density measurements and growth curves of GAB cultures after 1 hour of exposure to high concentrations of Sample 181 according to one or more embodiments shown and described herein;

FIG. 9 is a schematic representation of the optical density measurements and growth curves of GAB cultures after 2 hours of exposure to high concentrations of Sample 181 according to one or more embodiments shown and described herein;

FIG. 10 is a schematic representation of the optical density measurements and growth curves of GAB cultures after 4 hours of exposure to high concentrations of Sample 181 according to one or more embodiments shown and described herein; and

FIG. 11 is a schematic representation of the biocidal efficiency of Sample 162 and Sample 181 with commercial sample at 1 hour of contact time according to one or more embodiments shown and described herein.

Reference will now be made in greater detail to various embodiments, some embodiments of which are illustrated in the accompanying drawings.

### DETAILED DESCRIPTION

Embodiments of the present disclosure are directed to processes for inhibiting microbial growth.

As used herein, the term “active component” is defined as a component in a biocide formulation that acts to mitigate microbial growth. Active components are distinguished from inactive components, which mainly serve as a vehicle to convey an active component. Biocide formulations according to embodiments described herein may include one or more active components.

As used herein, “the active component” or “active compound” refers to the component in a biocide formulation that acts to mitigate corrosion of a material to a greater extent than any other individual component in the corrosion inhibitor formulation.

As used herein, “parts per million” or “ppm” refers to parts per million by weight.

It was discovered that embodiments of processes described herein that include administering a formulation comprising a pyridinium chloride of Formula (I) may exhibit superior microbial control and corrosion inhibiting efficiency compared with conventional corrosion inhibitors. Specifically, according to embodiments described herein, the pyridinium chloride compounds of Formula (1), which can be an active compound or an intermediate compound, may be used directly as an effective biocide as well as a dual product for microbial and corrosion control. Without being bound by theory, it is believed that pyridinium salts of alkyl-epoxides could be used as biocides themselves, or, as part of a formulation with comparable results to conventional biocides and biocide formulations. Thus, it is believed that biocide formulations described herein behave as active intermediates as biocide to mitigate the challenge of microorganism or bacterial in the oil and gas industry.

According to embodiments, a process for inhibiting microbial growth may include administering a formulation comprising a pyridine chloride compound of Formula (I)

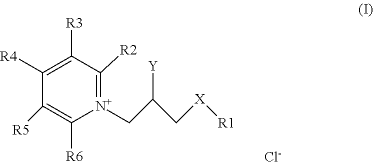

wherein R₁-R₆ independently comprise hydrogen, substituted or unsubstituted C₁ to C₂₄ alkyl, substituted or unsubstituted alkylaryl, substituted or unsubstituted aryl, substituted or unsubstituted heteroaryl, substituted or unsubstituted alkenyl, substituted or unsubstituted alkynyl, sulfonate, aryl sulfonate, C₁ to C₂₄ alkyl sulfonate, taurine, carboxylate, amine, alkylamine, arylamine, alkylammonium, arylammonium, sulfonamide, halogen, hydroxy, amide, nitro, cyano, azide, O-alkyl, S-alkyl, silyl, trialkylsilyl, O-silyl, haloalkyl, alkylsulfhydryl, trifluoromethyl, hydrazide, substituted or unsubstituted aryl, heteroaryl, or heterocyclic alkynyl, carboxyalkyl, aminoalkyl, haloalkyl, azidoalkyl, amide, amino acid, or peptide. and X and Y in Formula (I) independently comprise a heteroatom selected from oxygen, nitrogen, or sulfur, or a heterocarbyl comprising one or more heteroatoms selected from oxygen, nitrogen, or sulfur. In specific embodiments, R₂, R₃, R₄, R₅, and R₆ in Formula (I) are independently hydrogen, and R₁ in Formula (I) is an unsubstituted C₅ to C₁₅ alkyl. In specific embodiments, Y in Formula (I) comprise a hydroxyl group. In specific embodiments, X in Formula (I) comprise an oxygen.

In specific embodiments, the pyridinium chloride compound is 1-(2-hydroxyalkyl) pyridinium-chloride or 1-[3-(Octyloxy/Decyloxy)-2-hydroxypropyl]pyridinium-chloride. In embodiments, the pytridnium chloride compound is 1-(2-hydroxymethyl) pyridinium-chloride, 1-(2-hydroxyethyl) pyridinium-chloride, 1-(2-hydroxypropyl) pyridinium-chloride, 1-(2-hydroxybutyl) pyridinium-chloride, 1-(2-hydroxypentyl) pyridinium-chloride, 1-(2-hydroxyhexyl) pyridinium-chloride, 1-(2-hydroxyheptyl) pyridinium-chloride, 1-(2-hydroxyoctyl) pyridinium-chloride, 1-(2-hydroxynonyl) pyridinium-chloride, 1-(2-hydroxydecyl) pyridinium-chloride, 1-[3-(Octyloxy/Decyloxy)-2-hydroxypropyl]pyridinium-chloride, or combinations thereof.

In other embodiments, X in Formula (I) comprises an ether. In specific embodiments, the ether compound may comprise hydrogen, substituted or unsubstituted C₁ to C₂₄ alkyl, substituted or unsubstituted alkylaryl, substituted or unsubstituted aryl, substituted or unsubstituted heteroaryl, substituted or unsubstituted alkenyl, substituted or unsubstituted alkynyl, sulfonate, aryl sulfonate, C₁ to C₂₄ alkyl sulfonate, taurine, carboxylate, amine, alkylamine, arylamine, alkylammonium, arylammonium, sulfonamide, halogen, hydroxy, amide, nitro, cyano, azide, O-alkyl, S-alkyl, silyl, trialkylsilyl, O-silyl, haloalkyl, alkylsulfhydryl, trifluoromethyl, hydrazide, substituted or unsubstituted aryl, heteroaryl, or heterocyclic alkynyl, carboxyalkyl, aminoalkyl, haloalkyl, azidoalkyl, amide, amino acid, or peptide.

In embodiments, the pyridinium chloride compound of Formula (I) is dissolved in a solvent. In other embodiments, the solvent comprises at least one of water or an alcohol. In embodiments, the alcohol is ethylene glycol, or ethylene diamine. Without being bound by theory, it is believed that other suitable alcohols may include monoethylene glycol (MEG), diethylene glycol monoethyl ether (DGME), and 2-butoxyethanol. In specific embodiments, the solvent comprises at least one of water, ethylene glycol, or ethylene diamine.

In embodiments, the pyridinium chloride compound of Formula (I) has an average molecular mass ranging from 100 m/z to 1500 m/z. According to one or more embodiments, the compound is present in the formulation at an average molecular mass of from 100 m/z to 1300 m/z, from 100 m/z to 1100 m/z, from 100 m/z to 900 m/z, from 100 m/z to 700 m/z, from 100 m/z to 500 m/z, from 100 m/z to 300 m/z, from 200 m/z to 1400 m/z, from 200 m/z to 1200 m/z, from 200 m/z to 1000 m/z, from 200 m/z to 800 m/z, from 200 m/z to 600 m/z, or even from 200 m/z to 400 m/z.

In embodiments, the formulation may be used to inhibit corrosion and microbial growth of a material. In some embodiments, the formulation may be used to inhibit corrosion and microbial growth of a metallic surface, such as a metallic surface in a wet sour environment. In embodiments, a process for inhibiting microbial growth includes contacting a metallic surface with a biocide formulation according to embodiments described herein.

According to embodiments, the metallic surface comprises steel. In some embodiments, the metallic surface comprises carbon steel. In embodiments, the metallic surface may be contacted with the biocide formulation at least one time, at least two times, at least three times, at least four times, or even at least five times. It should be understood that when the metallic surface is contacted with the biocide formulation multiple times, each contacting may be accomplished using the same or different concentrations of the compound described herein.

Without being bound by theory, formulations described herein may exhibit a higher corrosion inhibition efficiency than conventional biocide formulations. In embodiments, formulations described herein may exhibit a corrosion inhibition efficiency that is at least 5%, at least 10%, at least 15%, at least 20%, at least 25%, or at least 30% greater than conventional corrosion inhibitor formulations. Because embodiments of the formulations described herein may exhibit a greater corrosion inhibition efficiency than conventional corrosion inhibitor formulations, a lower dosage of the corrosion inhibitor formulations described herein may provide a metallic surface with the same or even greater protection from corrosion than a higher dosage of a conventional corrosion inhibitor formulation. As such, formulations described herein may be more efficient and cost-effective than conventional corrosion inhibitor formulations.

According to a first aspect, a process for inhibiting microbial growth comprises administering a formulation comprising a pyridinium chloride compound of Formula (I) wherein R₁-R₆ independently comprise hydrogen, substituted or unsubstituted C₁ to C₂₄ alkyl, substituted or unsubstituted alkylaryl, substituted or unsubstituted aryl, substituted or unsubstituted heteroaryl, substituted or unsubstituted alkenyl, substituted or unsubstituted alkynyl, sulfonate, aryl sulfonate, C₁ to C₂₄ alkyl sulfonate, taurine, carboxylate, amine, alkylamine, arylamine, alkylammonium, arylammonium, sulfonamide, halogen, hydroxy, amide, nitro, cyano, azide, O-alkyl, S-alkyl, silyl, trialkylsilyl, O-silyl, haloalkyl, alkylsulfhydryl, trifluoromethyl, hydrazide, substituted or unsubstituted aryl, heteroaryl, or heterocyclic alkynyl, carboxyalkyl, aminoalkyl, haloalkyl, azidoalkyl, amide, amino acid, or peptide; and X and Y independently comprise a heteroatom selected from oxygen, nitrogen, or sulfur, or a heterocarbyl comprising one or heteroatoms selected from oxygen, nitrogen, or sulfur.

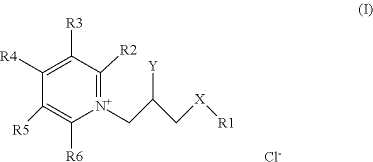

According to a second aspect, either alone or in combination with any other aspect, the pyridinium chloride compound of Formula (I) is dissolved in a solvent.

According to a third aspect, either alone or in combination with any other aspect, the solvent comprises one or more of water, ethylene glycol, or ethylene diamine.

According to a fourth aspect, either alone or in combination with any other aspect, R₂, R₃, R₄, R₅, and R₆ of Formula (I) are independently hydrogen, and R₁ is an unsubstituted C₅ to C₁₅ alkyl.

According to a fifth aspect, either alone or in combination with any other aspect, the pyridinium chloride compound is wherein the pyridinium chloride compound is 1-(2-hydroxyalkyl) pyridinium-chloride or 1-[3-(Octyloxy/Decyloxy)-2-hydroxypropyl]pyridinium-chloride.

According to a sixth aspect, either alone or in combination with any other aspect, the pyridinium chloride compound has an average molecular mass ranging from 100 m/z to 1500 m/z.

According to a seventh aspect, either alone or in combination with any other aspect, the formulation inhibits corrosion and microbial growth.

According to an eighth aspect, either alone or in combination with any other aspect, Y of Formula (I) is a hydroxyl group.

According to a ninth aspect, either alone or in combination with any other aspect, X of Formula (I) is an oxygen.

### EXAMPLES

Using embodiments described above, an exemplary formulation was prepared and used according to the following examples. The examples are illustrative in nature, and should not be understood to limit the subject matter of the present disclosure.

The following compositions were used in the Examples below.

Biocide chemicals—Sample 162 and Sample 181 are shown in Table 1.

A conventional biocide containing 20-60% glutaraldehyde-based biocide active ingredient was used as a comparative example below.

TABLE 1

| Biocide Examples | Structures |
|---|---|
| Example-1 (Sample 162) | 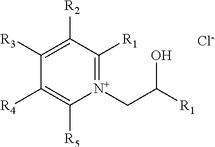 |
| Example-2 (Sample 181) | 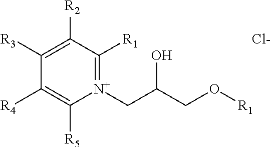 |

Biostatic and biocidal effects of Sample 162 and Sample 181 were tested using the consortium of general aerobic bacteria (GAB) isolated from the pipeline network of Qurayyah Seawater Injection Department (SWID), and enriched with GAB media prepared in Qurayyah seawater (QSW). The active GAB culture after overnight incubation at 35° C. with 150 rpm shaking was measured for optical density at 600 nm. The conversion factor was established between optical density reading and the counts of colony forming unit (CFU) of GAB by spread plating the active culture on Standard Plate Count Agar. The following conversion was used: optical density at 600 nm≈8.73×10⁹ CFU/mL of QSW GAB.

Optical density (OD) of various liquids and preparations used in the experiments was measured using a Bioscreen Instrument. The average OD for GAB media, H₂O, and QSW was 0.082, 0.088, and 0.097, respectively. Addition of 50 ppm or 100 ppm of Sample 162 and Sample 181 did not change base OD readings of GAB media, H₂O, and QSW. However, low OD readings (<0.1) are much less reproducible due to inherent weakness of OD method.

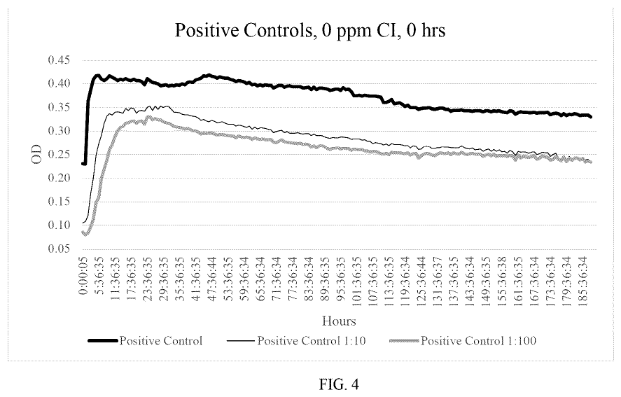

Sample 162 and Sample 181 were evaluated for biostatic effect at the final concentration of active ingredient of 1 ppm, 2.5 ppm and 5 ppm with continuous contact time. For biocidal effect, the evaluation was conducted at the final concentration of 25 ppm, 50 ppm, and 100 ppm with contact time of 1, 2, and 4 hours. To assess the biocidal effects at high concentrations, the undiluted overnight GAB culture with optical density equivalent to 0.36 was used. After the designated contact time, the biocidal chemicals were removed from the bacteria culture via centrifugation, at 4000 rpm for 15 minutes. The bacteria pellet was suspended in sterile GAB media before loaded to Bioscreen instrument for incubation and optical density measurement. Treated GAB cultures (0.4 mL) were distributed to the wells of a 10×10 plate. The plate was loaded to Bioscreen instrument, and incubated at 35° C. with medium shaking. Loss of bacteria pellets was observed after culture centrifugation and bacteria pellet resuspension. This was indicated by lower optical density readings (0.23 for undiluted GAB culture) immediately measured after the cultures were loaded to the Bioscreen plate wells as shown in FIG. 4. Optical density was recorded by the instrument every hour at 600 nm. Various positive and negative controls were also set up along with the treatment experiments.

The most probable number (MPN) method was also used to determine the surviving bacteria after exposure to the corrosion inhibiting biocides herein and confirm the results of Bioscreen instrument.

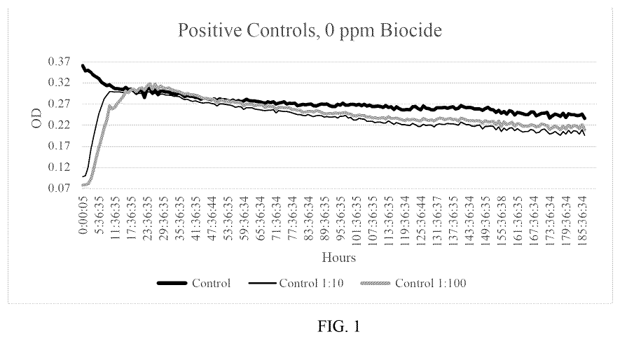

Now, referring to FIG. 1, the overnight GAB culture had an optical density reading of 0.36 (3.14×10⁹ CFU/mL of GAB). The culture was then diluted to 1:10 and 1:100 in QSW-GAB media. Undiluted and diluted GAB culture were set up as positive controls, and the optical density was measured by Bioscreen instrument every hour during the experiment period as shown in FIG. 1. Due to its high initial concentration, the undiluted GAB culture did not grow after transfer to the Bioscreen plate wells, as indicated by the decreasing optical density reading. The diluted cultures (1:10 and 1:100) showed quick growth, reaching optical density plateau approximately 12 hours to 26 hours after being transferred to the Bioscreen plate wells. Thus, undiluted GAB cultures were used in further experiments.

### Example 1—Sample 162

### Low Concentrations of Sample 162

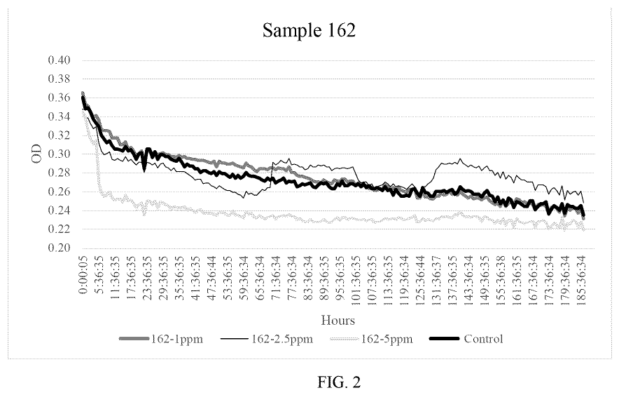

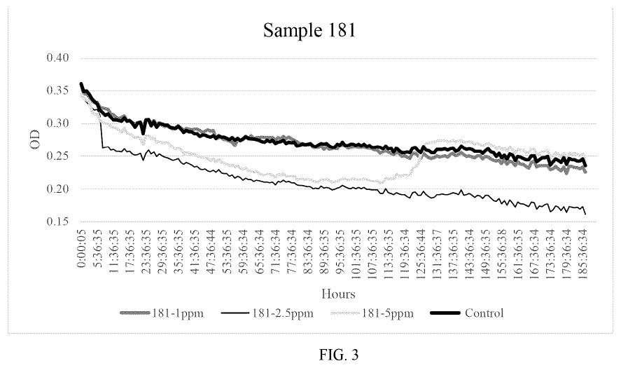

FIG. 2 and FIG. 3 demonstrate optical density measurements and growth curves of GAB cultures after the addition of low concentrations of Sample 162 and Sample 181, respectively. Referring to FIG. 2, Sample 162 treatment at 5 ppm showed inhibition of GAB growth for the whole experimental period (˜186 hours). The optical density of GAB culture decreased quickly in 8 hours after treatment, and continued to decrease, and maintained at lower level (OD≈0.22). On the other hand, Sample 162 treatment at 2.5 ppm only showed inhibition of GAB growth for approximately 60 hours. 1 ppm treatment actually showed higher optical density readings in 1^{st} 100 hours, compared to the no treatment control. The results indicated that low concentration of biocide may actually serve as nutrient source to support GAB growth.

### High Concentrations of Sample 162

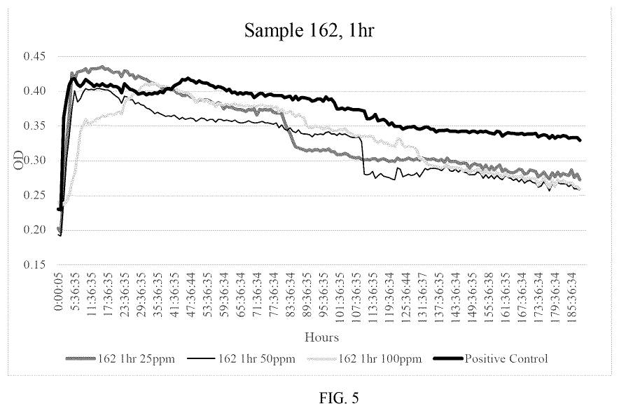

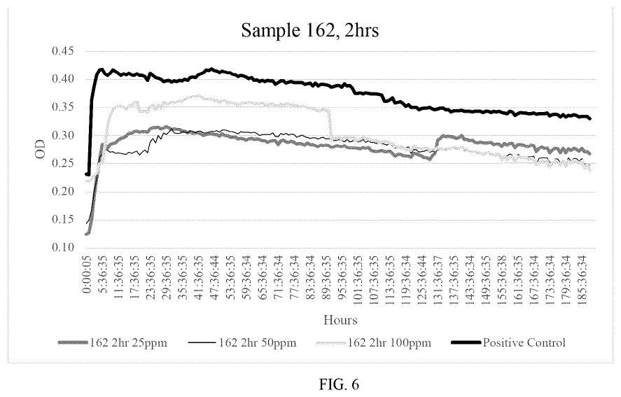

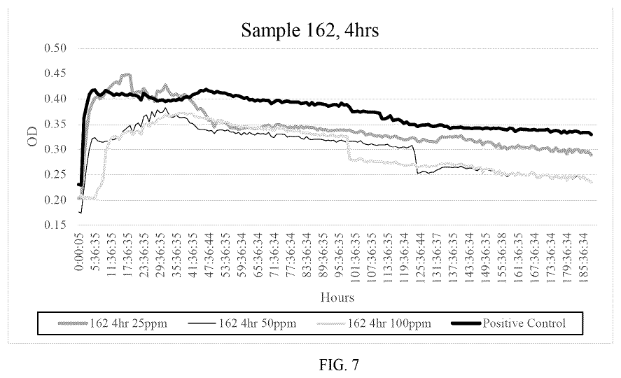

FIG. 5 demonstrates that with 1 hour contact time of Sample 162, 50 ppm and 100 ppm treatments showed GAB optical density readings lower than the no treatment control during whole experimental period. Furthermore, FIG. 5 also demonstrates that 50 ppm treatment showed slightly lower optical density reading compared to 100 ppm. At the end of the experiment, 50 ppm treatment for 1 hour showed optical density 0.27, compared to optical density 0.33 of no treatment control. FIG. 6 demonstrates that with 2 hours contact time, 25 ppm and 50 ppm of Sample 162 showed similar optical density readings of GAB culture, but at 25 ppm, optical density started to increase after 128 hours (˜5 days). Furthermore, 100 ppm treatment showed a quick increase of optical density reading, reaching higher optical density readings than 25 and 50 ppm, but optical density decreased to the similar level after 90 hours to the optical density of 25 and 50 ppm treatments. Overall, 2 hours treatment has lower optical density readings of GAB culture than 1 hour treatment. At the end of the experiment, 50 ppm treatment showed optical density of 0.25, compared to the control optical density 0.33. Referring to FIG. 7, with 4 hours contact time of Sample 162, 25 ppm treatment showed a quick comeback of GAB with higher optical density than 50 ppm and 100 ppm treatments. Moreover, 50 ppm and 100 ppm showed a similar optical density readings of GAB culture after treatment, with similar optical density reading at the end (OD≈0.24). 4 hours treatment did not show improved GAB control over 2 hours treatment.

In conclusion, with Sample 162, the best GAB control based on OD measurements was achieved at 50 ppm and 2 hours contact time, at which the highest OD was 0.31 and the lowest was 0.25 at the end of the experiment (˜186 hours).

### Example 2—Sample 181

### Low Concentrations of Sample 181

FIG. 3 demonstrates the results of treatment with low concentrations of Sample 181. At 2.5 ppm, Sample 181 inhibited the GAB growth for the whole experimental period (˜186 hours). Furthermore, the optical density of GAB culture decreased quickly in 8 hours after treatment, and continued to decrease during whole experiment (OD=0.161). On the other hand, Sample 181 treatment at 1 ppm did not show biostatic effect as compared to the no treatment control. The treatment effect at 5 ppm falls in the middle. The optical density readings decreased to 0.209 within 4.5 days (˜110 hours), followed by optical density increasing to the levels higher than no treatment control. Now, referring to FIG. 2 and FIG. 3, 5 ppm of Sample 162 and 2.5 ppm of Sample 181 showed biostatic inhibition of GAB growth based on optical density measurements, with inhibitory effect lasting for at least 7 days. However, the optical density reading may not represent the true surviving bacteria after the treatment, and the results need to be confirmed with MPN methods.

### High Concentrations of Sample 181

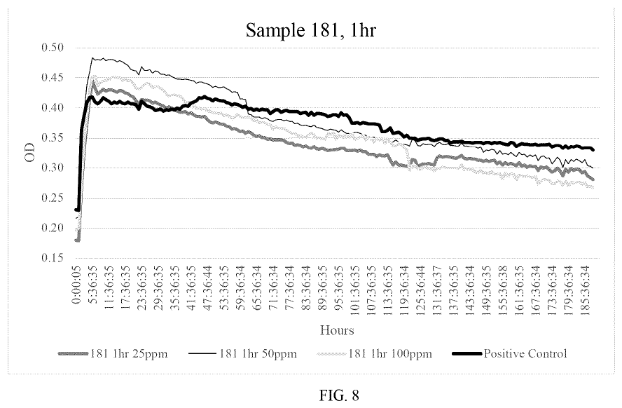

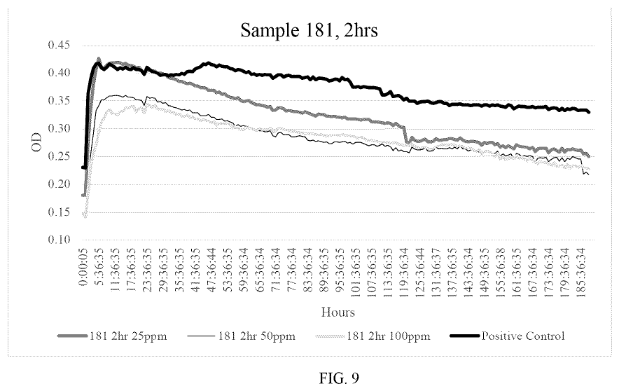

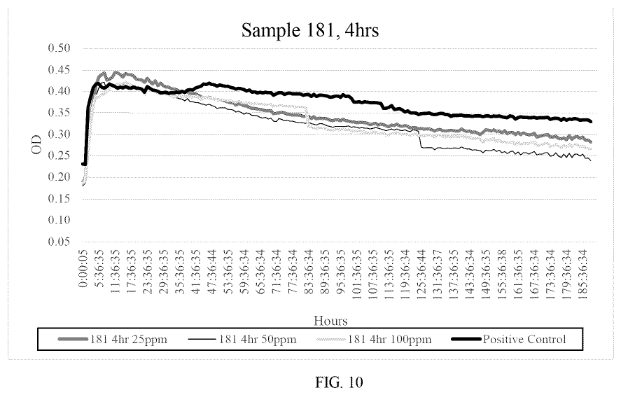

FIG. 8 demonstrates that the 1 hour contact time to Sample 181 showed peak GAB OD readings higher than no treatment control. Then the optical density readings decreased to the level lower than control after 40-60 hours. Furthermore, FIG. 9 demonstrates that with 2 hours of exposure to Sample 181, cultures exposed to 50 ppm and 100 ppm showed lower optical density readings of GAB culture compared to 25 ppm treatment and no treatment control. Now, referring to FIG. 10, the optical density reduced to ˜0.23 at the end of the experimental period. The results of optical density measurement after 4 hours treatment fell in between 1 and 2 hours of treatment.

Starting at lower cell concentration due to loss of cell pellet from the centrifugation, undiluted GAB culture showed a quick growth to reach optical density plateau at 0.417 in ˜6 hours, followed by slow decline of optical density during the experimental period. Diluted GAB cultures (1:10 and 1:100) showed the similar growth curves, reaching optical density plateau at 0.35 and 0.33 in approx. 18 hours and 24 hours, respectively, followed by steadily decline of optical density readings.

In conclusion, with Sample 181, the best GAB control based on optical density measurements was achieved at 50 ppm or 100 ppm with 2 hours of contact time. The highest optical density was 0.36 and the lowest was 0.23 at the end of the experiment (˜186 hours).

Now, referring to FIG. 6 and FIG. 9, batch treatment at 50 ppm biocide and 2 hours of contact time of Sample 162, and batch treatment at 50-100 ppm biocide and 2 hours of contact time of Sample 181 showed the best GAB control based on optical density measurements. The final optical density readings at the end of the experiment from Sample 162 at 50 ppm biocide and 2 hours treatment were 0.25, while the Sample 181 at 50-100 ppm biocide and 2 hour treatment gave 0.23 final optical density readings, both lower than optical density of 0.33 in the no treatment control. However, optical density readings may not represent the true surviving bacteria after the treatment, and the results need to be confirmed with MPN methods.

To confirm the performance results of Sample 162 and Sample 181 as biostats or biocides at low or high concentrations, the surviving GAB number after chemical treatments was determined using MPN methods.

The active GAB culture was prepared as described herein. The culture was diluted 100-fold in QSW GAB media, and 1 mL of diluted culture was added to vials containing 9 mL of growth media before the biocide treatment.

For biostatic experiment at low concentration, Sample 162 and Sample 181 were added to the GAB culture vials at the final concentrations of 2.5 ppm and 5 ppm. These vials containing GAB culture and biocide chemicals were left at room temperature for one week (continuous contact). Each day, a 1 mL sample was taken for a total of seven days from the vials to set up MPN tests to determine the number of surviving bacteria after exposure to biocide. The MPN experiment was set up in single 8-dilution series, and the vials were incubated at 35° C. for one week. The MPN enumeration is based on turbidity readings of the vials and statistical MPN table. Positive MPN controls (triplicate, 12-dilution) were also set up to determine the GAB number in the original culture and the culture after one-week incubation without exposing to biocide chemicals.

The results of biostatic experiment at low concentration was shown in Table 2. It is noted that when all vials (8-dilution series or 12-dilution series) turned to turbid (an indication of bacteria growth), the MPN result is expressed as “greater than”. The original GAB culture used in the experiment has GAB concentration at 1.5×10¹⁰/mL, which increased to greater than 2.3×10¹¹/mL after one week at room temperature without CI treatment. The samples taken after every 24 hrs exposure to Sample 162 and Sample 181 (2.5 ppm or 5 ppm) turned to turbid in all 8-dilutions, and the results of surviving GAB can only be expressed as greater than 1.0×10⁸/mL. Since it is not possible to compare the results (>1.0×10⁸/mL and >2.3×10¹¹/mL), no firm conclusion can be drawn regarding the biostatic efficacy of these two chemicals from this experiment. For a firm conclusion, a new experiment was required with low starting bacteria concentration so that the number of surviving bacteria can be more accurately estimated and compared to the no treatment control. After discussion with the proponent, it is decided that the experiment will be repeated on the actual formulations when they are ready.

TABLE 2
Results of surviving GAB (MPN/mL) after exposure to
low concentrations of Sample 162 and Sample 181.

| | |
|---|---|
| Sample-162 | Sample-181 |

| Day # | 2.5 ppm | 5.0 ppm | 2.5 ppm | 5.0 ppm |
|---|---|---|---|---|
| 1 | >1.0E+08 | >1.0E+08 | >1.0E+08 | >1.0E+08 |
| 2 | >1.0E+08 | >1.0E+08 | >1.0E+08 | >1.0E+08 |
| 3 | >1.0E+08 | >1.0E+08 | >1.0E+08 | >1.0E+08 |
| 4 | >1.0E+08 | >1.0E+08 | >1.0E+08 | >1.0E+08 |
| 5 | >1.0E+08 | >1.0E+08 | >1.0E+08 | >1.0E+08 |
| 6 | >1.0E+08 | >1.0E+08 | >1.0E+08 | >1.0E+08 |
| 7 | >1.0E+08 | >1.0E+08 | >1.0E+08 | >1.0E+08 |

| | |
|---|---|
| Control 1 | GAB in original culture |
| | 1.50E+10 |
| Control 2 | GAB after 7-day at RT |
| | >2.3E+11 |

For biocidal experiments at high concentration, an amount of either Sample 162 or Sample 181 was added to the GAB culture vials at the final concentrations of 50 ppm and 100 ppm. After 1 hour and 2 hours of contact time, 1 mL of culture was taken to set up MPN tests in triplicate, 8-dilution series, and incubated at 35° C. for one week before scoring positive and negative growth for enumeration of surviving GAB. Positive MPN control (triplicate, 12-dilution) was also set up to determine the GAB number in the original culture without exposing to corrosion inhibitor chemicals.

The results of biocidal experiment at high concentration are demonstrated in Table 3. The GAB culture in the absence of the corrosion inhibitor treatment has GAB concentration at 2.1×10⁹/mL. After 1 hour or 2 hours of exposure to 50 ppm of Sample 162 and 50 ppm and 100 ppm of Sample 181, the surviving GAB number was greater than 2.3×10⁷/mL. Therefore, the results cannot draw a solid conclusion whether these two corrosion inhibiting chemicals have biocidal effect against QSW GAB under these treatment conditions. However, at 100 ppm of Sample 162, the surviving GAB number was 4.3×10⁶/mL and 1.5×10⁶/mL after 1 hour and 2 hours contact time, which are 3-log reduction compared to the control culture without treatment.

TABLE 3
Results of surviving GAB (MPN/mL) after exposure to
50 ppm and 100 ppm of Sample 162 and Sample 181.

| | | |
|---|---|---|
| Contact | Sample 162 | Sample 181 |

| time | 50 ppm | 100 ppm | 50 ppm | 100 ppm |
|---|---|---|---|---|
| 1 hr | >2.3E+07 | 4.30E+06 | >2.3E+07 | >2.3E+07 |
| 2 hrs | >2.3E+07 | 1.50E+06 | >2.3E+07 | >2.3E+07 |

| | |
|---|---|
| Control | 2.10E+09 |

The biocidal experiment was repeated at 200 ppm, 300 ppm, and 600 ppm of Sample 162 and Sample 181. In addition, a commercial glutaraldehyde-based biocide was included for comparison of biocidal efficacy. The GAB culture was exposed to 1000 ppm of product, which is equivalent to 200-600 ppm of active glutaraldehyde. The results are shown in Table 4. The biocidal efficacy of Sample 162 is comparable with that of the comparative glutaraldehyde-based biocide with below detection limit of surviving GAB at 300 ppm and 600 ppm after 1 hour and 2 hours contact time. Sample 181 also showed biocidal effect, but at much lower efficacy compared to Sample 162. It is noted; however, the experiment was conducted on the actives, not on the formulation. In general, the formulation is designed to provide synergy between actives and proprietary additives with increased stability and enhanced effectiveness for the intended applications.

TABLE 4
Results of surviving GAB (MPN/mL) after exposure
to 200-600 ppm of Sample 162 and Sample 181.

Contact time

| | | | |
|---|---|---|---|
| Chemicals | Conc. | 1 hr | 2 hrs |

| | | | | |
|---|---|---|---|---|
| Sample 162 | 200 | ppm | 4.3 | 1.50E+02 |
| | 300 | ppm | <0.4 | <0.4 |
| | 600 | ppm | <0.4 | <0.4 |
| Sample 181 | 200 | ppm | 1.50E+06 | 7.50E+04 |
| | 300 | ppm | 7.50E+04 | 4.30E+05 |
| | 600 | ppm | 9.30E+03 | 2.30E+02 |
| Comparative | 200~600 | ppm | <0.4 | <0.4 |

| | | | |
|---|---|---|---|
| Control | 0 | ppm | 4.30E+09 |

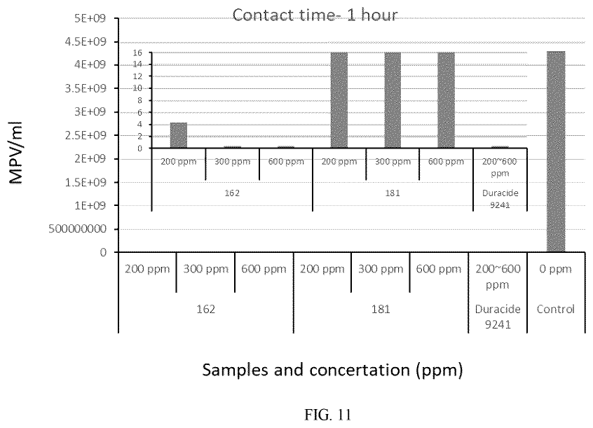

FIG. 11 demonstrates the performance comparison of Sample 162 and Sample 181 based on inhibition efficiency at 1 hour contact time.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in embodiments, the first component “consists” or “consists essentially of” that second component.

It should be understood that any ranges provided herein include the endpoints unless stated otherwise.

It should be understood that any two quantitative values assigned to a property may constitute a range of that property, and all combinations of ranges formed from all stated quantitative values of a given property are contemplated in this disclosure.

It is also noted that recitations herein of “at least one” component, element, etc., should not be used to create an inference that the alternative use of the articles “a” or “an” should be limited to a single component, element, etc.

For the purposes of describing and defining the presently disclosed technology it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

What is claimed is:

1. A process for inhibiting microbial growth, the process comprising:
administering a formulation comprising a pyridinium chloride compound of Formula (I), wherein 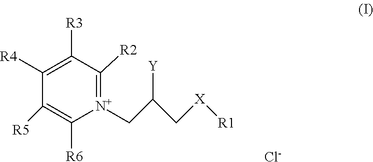
wherein R₁-R₆, independently comprise hydrogen, substituted or unsubstituted C₁ to C₂₄ alkyl, substituted or unsubstituted alkylaryl, substituted or unsubstituted aryl, substituted or unsubstituted heteroaryl, substituted or unsubstituted alkenyl, substituted or unsubstituted alkynyl, sulfonate, aryl sulfonate, C₁ to C₂₄ alkyl sulfonate, taurine, carboxylate, amine, alkylamine, arylamine, alkylammonium, arylammonium, sulfonamide, halogen, hydroxy, amide, nitro, cyano, azide, O-alkyl, S-alkyl, silyl, trialkylsilyl, O-silyl, haloalkyl, alkylsulfhydryl, trifluoromethyl, hydrazide, substituted or unsubstituted aryl, heteroaryl, or heterocyclic alkynyl, carboxyalkyl, aminoalkyl, haloalkyl, azidoalkyl, amide, amino acid, or peptide; and
X and Y independently comprise a heteroatom selected from oxygen, nitrogen, or sulfur, or a heterocarbyl comprising one or heteroatoms selected from oxygen, nitrogen, or sulfur.

2. The process of claim 1, wherein the pyridinium chloride compound of Formula (I) is dissolved in a solvent.

3. The process of claim 2, wherein the solvent comprises one or more of water, ethylene glycol, or ethylene diamine.

4. The process of claim 1, wherein R₂, R₃, R₄, R₅, and R₆ are independently hydrogen, and R₁ is an unsubstituted C₅ to C₁₅ alkyl.

5. The process of claim 1, wherein the pyridinium chloride compound is 1-(2-hydroxyalkyl) pyridinium-chloride or 1-[3-(Octyloxy/Decyloxy)-2-hydroxypropyl]pyridinium-chloride.

6. The process of claim 1, wherein the pyridinium chloride compound has an average molecular mass ranging from 100 m/z to 1500 m/z.

7. The process of claim 1, wherein the formulation inhibits corrosion and microbial growth.

8. The process of claim 1, wherein Y is OH.

9. The process of claim 1, wherein X is O.
